(19) United States
(12) Patent Application Publication
(10) Pub. No.: US 2019/0015960 A1
(43) Pub. Date: Jan. 17, 2019

(54) WRENCH WITH A MOVABLE POSITIONING ROD

(71) Applicant: Shwu-Ruu Chern, Taichung (TW)

(72) Inventor: Shwu-Ruu Chern, Taichung (TW)

(21) Appl. No.: 15/650,898

(22) Filed: Jul. 15, 2017

(51) Int. Cl. B25B 23/00; B25G 1/06; B25F 1/00; B25B 13/46

(52) U.S. Cl. CPC B25B 23/00; B25G 1/063; B25B 13/00; B25B 13/46; B25F 1/00

(57) ABSTRACT

A wrench includes a body having a room defined therein. Two heads are respectively formed on two ends of the body, and each head has an operation hole defined therethrough. Each of the operation holes communicates with the room. A positioning rod is movably received in the room and has an outer threaded portion and a rotary member is rotatably and threadedly mounted to the outer threaded portion of the positioning rod. The rotary member is rotated to move the positioning rod into either one of the operation holes to position an object in the operation hole.

### BACKGROUND OF THE INVENTION

### 1. Fields of the Invention

The present invention relates to a wrench, and more particularly, to a wrench for operating objects of different sizes.

### 2. Descriptions of Related Art

One of the commonly used tool hands is ratchet wrench which includes a ratchet mechanism received in the wrench, and the pawl is controlled to be engaged with or disengaged from the driving gear received in the head of the wrench. The advantages of the ratchet wrenches are that the wrench does not need to be dismounted from the object when the wrench is rotated to an angle, and then is re-mounted to the object for another rotating action.

However, the conventional ratchet wrenches mostly have a complicated ratchet mechanism which is different assembled into a narrow space in the wrench. Besides, the conventional ratchet wrenches have to be cooperated with sockets to tighten or loosen the objects such as bolts or nuts.

The present invention intends to provide a wrench which eliminates the shortcomings mentioned above.

### SUMMARY OF THE INVENTION

The present invention relates to a wrench and comprises a body having a room defined in the top surface thereof. The body has two heads respectively formed on two ends thereof. Each head has an operation hole defined therethrough. Each of the operation holes communicates with the room. A first slot is defined through the bottom surface of the body and communicates with the room. A positioning rod is received in the room and has an outer threaded portion formed on the mediate portion thereof. A rotary member is rotatably and threadedly mounted to the outer threaded portion of the positioning rod. The rotary member is located in the first slot. A cover is connected to the top surface of the body and has a second slot. The rotary member partially protrudes from the second slot.

Preferably, the rotary member is a collar with inner threads, and has a serrated surface defined in the outer periphery thereof.

Preferably, the two operation holes have different inner diameters.

Preferably, the two operation holes are polygonal holes.

Preferably, the two operation holes are hexagonal holes.

Preferably, the body is an elongate body.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the wrench of the present invention;

FIG. 2 is an exploded view to show the wrench of the present invention;

FIG. 3 is another exploded view to show the wrench of the present invention;

FIG. 4 shows that the cover is to be installed to the top surface of the wrench of the present invention;

FIG. 5 is a plan view to show the positioning rod in the room of the body;

FIG. 6 shows the first operational status of the wrench of the present invention;

FIG. 7 shows the second operational status of the wrench of the present invention, and

FIG. 8 shows the third operational status of the wrench of the present invention.

### DETAILED DESCRIPTION OF THE PREFERRED EMBODIMENT

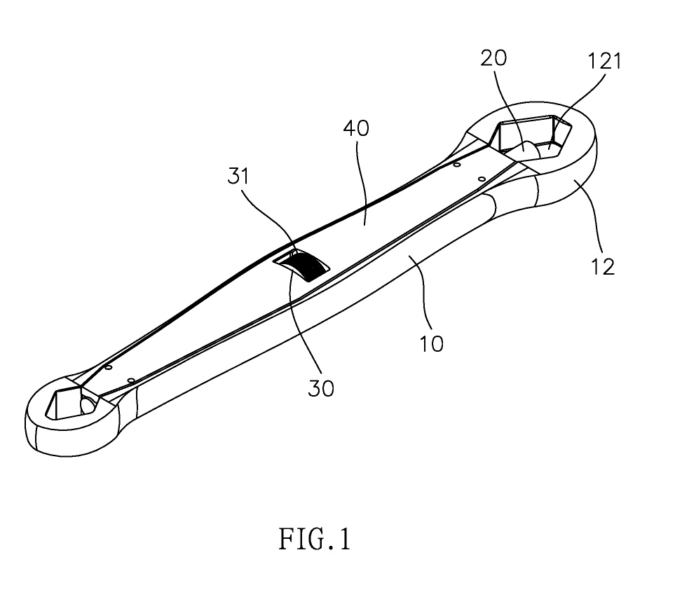

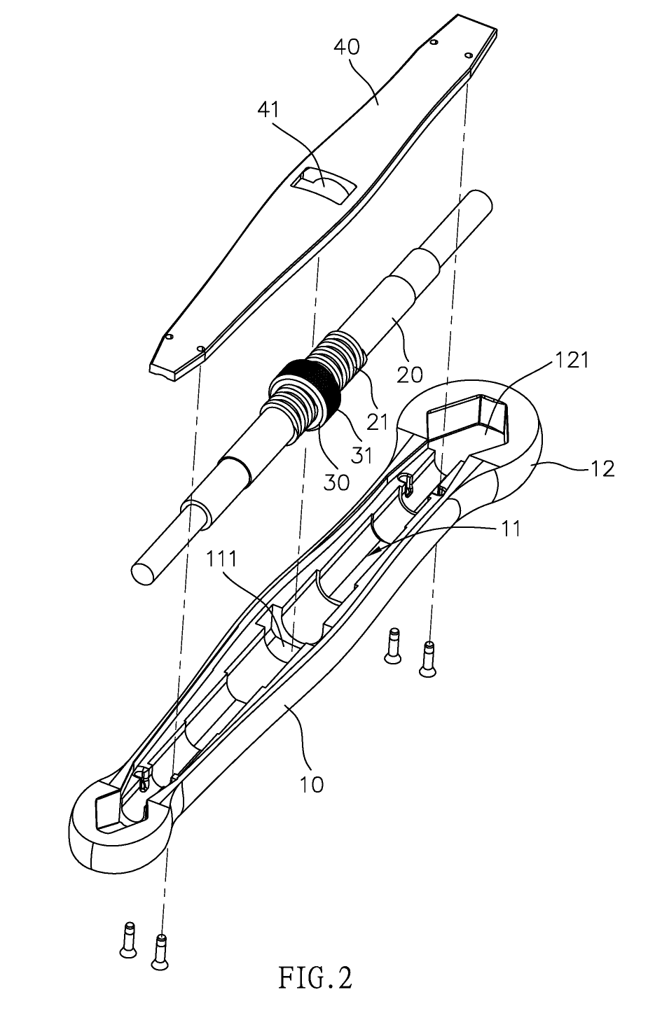

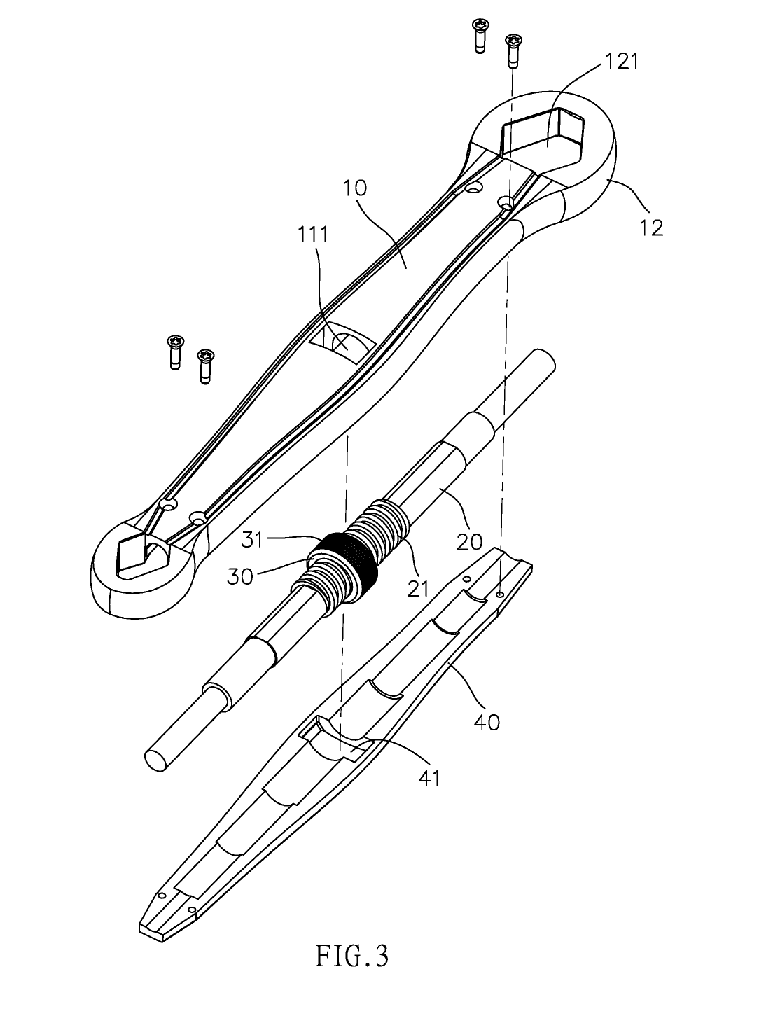

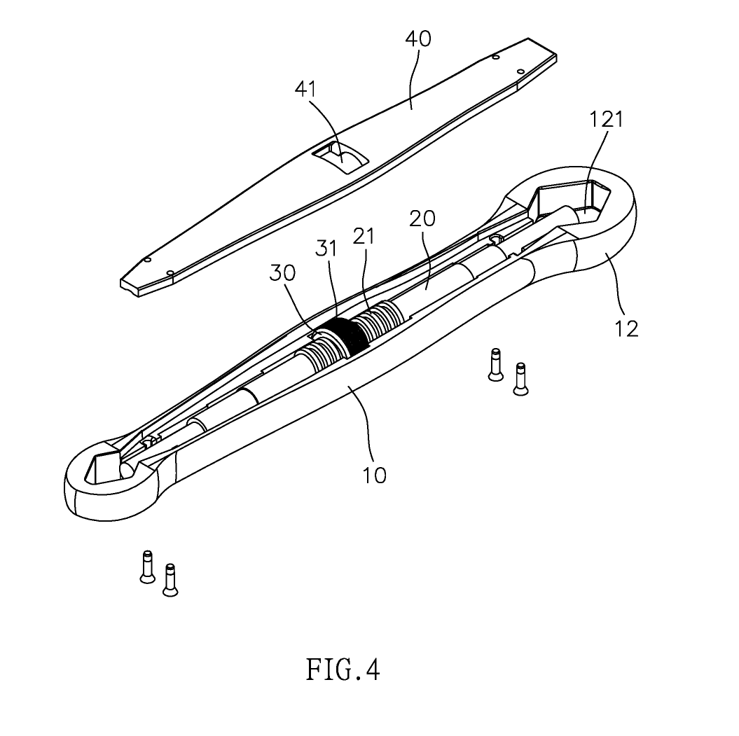

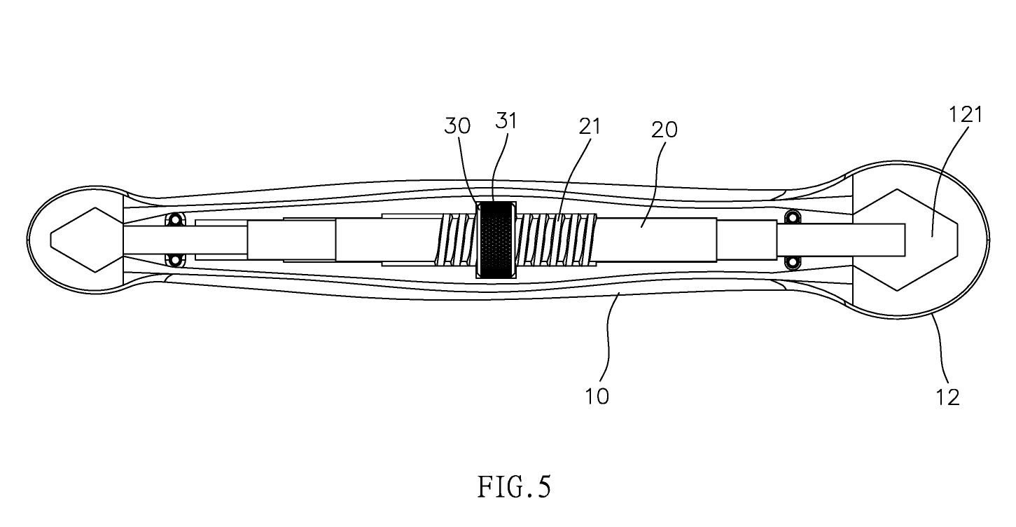

Referring to FIGS. 1 to 8, the wrench of the present invention comprises an elongate body 10 having a room 11 defined axially in the top surface thereof. Two heads 12 are respectively formed on two ends of the body 10, and each head 12 has an operation hole 121 defined therethrough. Each of the operation holes 121 communicates with the room 11 as shown in FIG. 2. A first slot 111 is defined through the bottom surface of the body 10 and communicates with the room 11.

A positioning rod 20 is received in the room 11 and has an outer threaded portion 21 formed on the mediate portion thereof. One of two ends of the positioning rod 20 extends into the operation hole 121 corresponding thereto.

A rotary member 30 is rotatably and threadedly mounted to the outer threaded portion 21 of the positioning rod 20. In this embodiment, the rotary member 30 is a collar with inner threads which are threadedly engaged with the outer threaded portion 21 of the positioning rod 20. The rotary member 30 has a serrated surface 31 defined in the outer periphery thereof. The rotary member 30 is located in the first slot 111. A cover 40 is connected to the top surface of the body 10 and seals the room 11. The cover 40 has a second slot 41, and the rotary member 30 partially protrudes from the second slot 41.

It is noted that the two operation holes 121 are polygonal holes and have different inner diameters. Specifically, the two operation holes 121 are hexagonal holes.

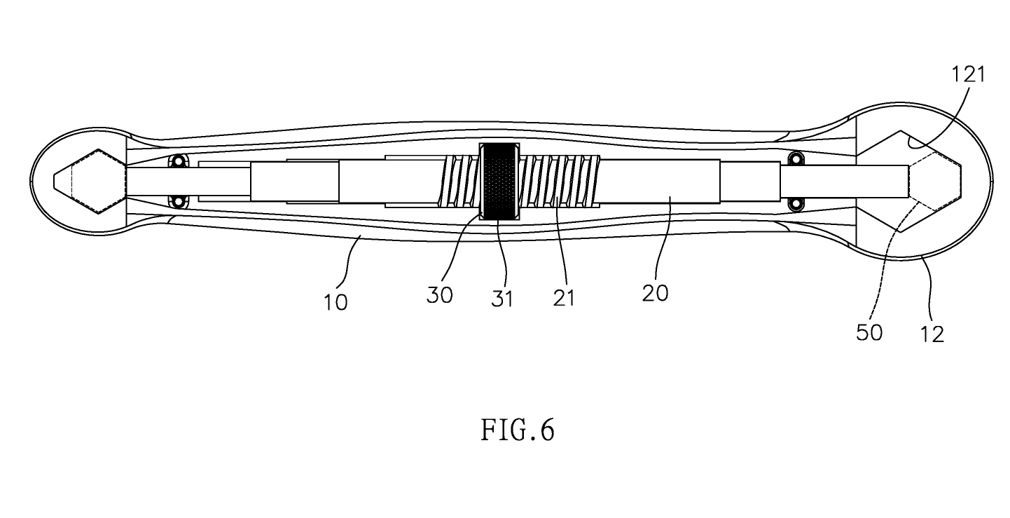

As shown in FIGS. 6 to 8, when using the wrench, the object 50 is received in one of the operation holes 121, and the user rotates the rotary member 30 to drive the positioning rod 20 to move until the distal end of the positioning rod 20 contacts against the object 50 as shown in FIG. 6. The object 50 is then securely positioned in the operation hole 121, and the user simply rotates the handle 10 to tighten or loosen the object 50.

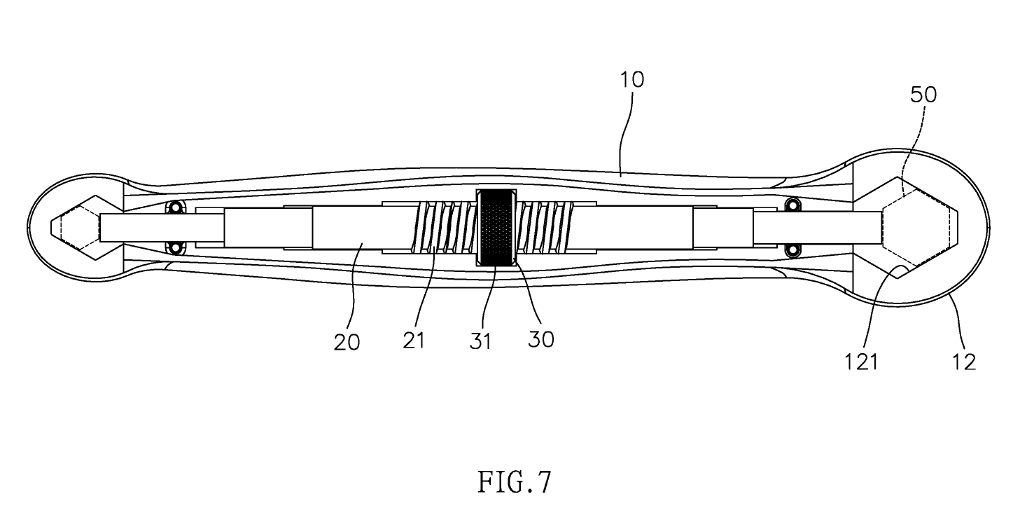

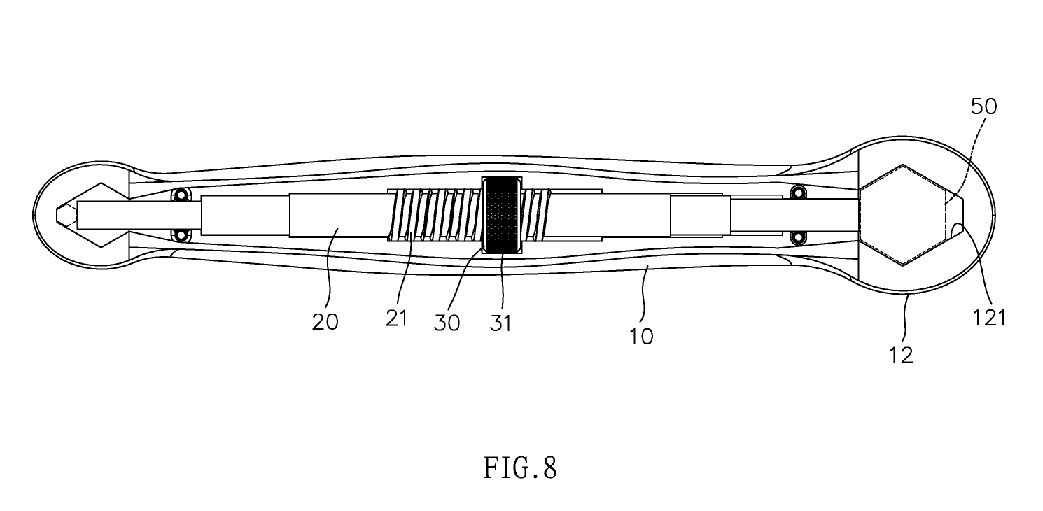

The objects 50 of different sizes can be securely positioned in the operation hole 121 by rotating the rotary member 30 as shown in FIGS. 7 and 8. The wrench has a simple structure without a complicated ratchet mechanism, and the wrench can operate the objects 50 of different sizes without using sockets.

While we have shown and described the embodiment in accordance with the present invention, it should be clear to those skilled in the art that further embodiments may be made without departing from the scope of the present invention.

What is claimed is:

1. A wrench comprising:
a body having a room defined in a top surface thereof, two heads respectively formed on two ends of the body, each head having an operation hole defined therethrough, each of the operation holes communicating with the room, a first slot defined through a bottom surface of the body and communicating with the room;
a positioning rod received in the room and having an outer threaded portion formed on a mediate portion thereof;
a rotary member rotatably and threadedly mounted to the outer threaded portion of the positioning rod, the rotary member located in the first slot, and
a cover connected to the top surface of the body and having a second slot, the rotary member partially protruding from the second slot.

2. The wrench as claimed in claim 1, wherein the rotary member is a collar with inner threads, the rotary member has a serrated surface defined in an outer periphery thereof.

3. The wrench as claimed in claim 1, wherein the two operation holes have different inner diameters.

4. The wrench as claimed in claim 1, wherein the two operation holes are polygonal holes.

5. The wrench as claimed in claim 4, wherein the two operation holes are hexagonal holes.

6. The wrench as claimed in claim 1, wherein the body is an elongate body.
